(19) United States
(12) Patent Application Publication
(10) Pub. No.: US 2019/0352060 A1
(43) Pub. Date: Nov. 21, 2019

(54) CONTAINER LID WITH INTEGRATED DISPENSER DRAWER

(71) Applicant: Johannes Petrus Van Der Westhuizen, Calgary (CA)

(72) Inventor: Johannes Petrus Van Der Westhuizen, Calgary (CA)

(21) Appl. No.: 16/405,620

(22) Filed: May 7, 2019

Related U.S. Application Data
(60) Provisional application No. 62/673,527, filed on May 18, 2018.

(51) Int. Cl. B65D 47/20; B65D 83/06; G01F 11/40

(52) U.S. Cl. CPC B65D 47/20; B65D 2547/04; G01F 11/40; B65D 83/06

(57) ABSTRACT

A drawer based dispensing system includes a drawer with receptacle moveable along a drawer guide between open and closed positions. During usage, a fill hole allows material from a container to enter the receptacle on a side of the drawer that faces an interior of the container when the drawer is positioned in the closed position. A dispensing hole allows material to exit the receptacle on an opposite side of the receptacle away from the interior of the container when the drawer is positioned in the open position. The dispensing system may be integrated into a lid of the container, which is flipped to sit lid-side-down by a user. A funnel may direct material into the fill hole. The drawer may extend to outside the container through an opening to expose the dispensing hole or the dispensing hole below the receptacle may align with a dispensing hole on the container.

### CROSS-REFERENCE TO RELATED APPLICATIONS

This application claims the benefit of priority of U.S. Provisional Application No. 62/673,527 filed May 18, 2018, which is incorporated herein by reference.

### BACKGROUND OF THE INVENTION

### (1) Field of the Invention

The invention pertains generally to containers for holding free-flowing materials. More specifically, the invention relates to a container lid with an integrated dispenser drawer for dispensing material from within the container.

### (2) Description of the Related Art

There are many products which are sold in large and small volume containers in which the material held within the container is free-flowing. The material may be a powder, liquid, sand, granular or other fluid-like substance. Specific examples of free-flowing materials include protein powder, dietary supplements, chocolate milk mix, powdered milk, powdered juice (e.g., lemonade), dietary additives, flour, sugar, or non-food items such as swimming pool chlorine, bird seed, dog food, gun powder, or other fluid-like bulk products. Containers for holding such materials often include a scoop so that a measured portion of the bulk or powdered substance held within the container can be scooped out.

One problem with having a scoop loose in the container is that the scoop can become buried in the product due to vibrations during shipping causing the material and scoop to shift around. A user may also misplace the scoop after usage. A typical solution to these missing scoop problems involves keeping another scoop on hand from a prior package so that if the current scoop is buried or missing, the prior scoop from an earlier purchase of the same product can be used. However, this solution obviously does not help users who do not have a prior scoop saved from an earlier purchase.

Another attempt to solve the missing scoop problem involves the manufacturer providing a clip allowing the scoop to be affixed to the underside of the container lid. However, some users may forget to return the scoop to the clip after each usage. Again, scoops sometimes get lost or misplaced by users; thus, even with a storage clip, the scoop may still go missing before all material in the container is used up.

Besides becoming lost, scoops are also problematic for other reasons. Scoops can become dusty from the material within the container rolling around the scoop during transport or during usage when the scoop is dipped into the material. A used scoop may be placed on an external surface such as a kitchen counter causing dust to be deposited onto the external surface. Some products such as swimming pool chlorine, or powdered laundry bleach, are harmful to the skin and contact with the product should be limited. It is undesirable to have dust from the scoop fall onto untended surfaces both for cleanliness and safety. Likewise, if the scoop is stored in the container, the user may inadvertently contact a potentially harmful substance within the container to retrieve the scoop. Some products may become spoiled or contaminated by repeated contact with the user's hands or the outside environment. Opening the container in order to scoop out material may provide an opportunity for bacteria or other contaminants to enter the container. The scoop itself may become wet or otherwise dirty and contaminate the material within the container.

### BRIEF SUMMARY OF THE INVENTION

According to an exemplary embodiment of the invention, a container lid has an integrated dispenser drawer that can be pulled opened and pushed closed by a user. The drawer has a receptacle of a predetermined size that fills with free-flowing material held in the container via a fill hole facing an inside of the container. Material enters the receptacle via the fill hole when the drawer is in a closed position. The receptacle further includes a dispensing hole opposite the fill hole and facing an outside of the container. When the drawer is in an opened position, material exits the receptacle via the dispensing hole.

During usage of the container lid, a user flips the container upside down and places the container lid-side-down on the edge of a table or similar surface. While the drawer is closed, powder or other free-flowing material in the container falls into the receptacle via the fill hole under the force of gravity and fills the receptacle. The drawer end has a lip or grove for accepting a top edge of a cup or glass so that a user can open and close the drawer by moving the cup or glass back and forth. Upon the user opening the drawer, material falls from the dispending hole of the receptacle into the user's cup or glass positioned under the dispensing hole. Multiple sets of material of the fixed quantity set according to the size of the receptacle may be dispensed in a similar manner by the user repeatedly opening and closing the drawer. For instance, if the dispenser receptacle holds thirty grams of material and the user wants ninety grams of the material, the user may open the drawer three times in sequence to thereby dispense three sets of thirty grams.

To help guide the material held in the container into the receptacle's fill hole under the force of gravity when the container is in the upside-down position, the container walls may be cone-shaped forming a funnel that empties into the receptacle's fill hole. Alternatively, an inner side of the lid may itself have an integrated funnel with a stem directing material directly into the receptacle's fill hole when the drawer is in the closed position thereby allowing the lid to be used with standard containers that do not include funnel-shaped walls.

According to an exemplary embodiment of the invention there is disclosed a lid for mounting on a container. The lid includes a base and a sidewall extending perpendicular from the base around at least part of a perimeter of the base. The lid further includes a guide track running across the base on a same side of the base as the sidewall and a drawer having a predetermined height mounted on the guide track and moveable along the guide track between an open position and a closed position. The lid further includes a receptacle for temporarily storing an amount of material within the predetermined height of the drawer. A fill hole allows a material in the container to enter the receptacle on a side of the drawer that faces an interior of the container when the drawer is positioned in the closed position. A dispensing hole allows material to exit the receptacle on an opposite side of the receptacle away from the interior of the container when the drawer is positioned in the open position.

According to an exemplary embodiment of the invention there is disclosed a method of dispensing material from a container having a lid with integrated dispenser drawer. The method includes orientating the container such that the container is lid-side-down and hooking a receiving container on a grove or notch connected to the integrated dispenser drawer. The method further includes moving the integrated dispenser drawer from a closed position to an open position in order to dispense a fixed amount of material from a receptacle in the drawer into the receiving container under the force of gravity via a dispensing hole under the receptacle, and moving the integrated dispenser drawer from the open position to the closed position in order to cause a fill hole above the receptacle to align internally with a fill stem internally thereby refilling the receptacle in the drawer with new material from the container interior. The method further includes repeating moving the integrated dispenser drawer between the closed position and the open position any number of times in order to dispense a desired amount of the material into the receiving container.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 illustrates an exploded view of a container, funnel and lid with integrated drawer in a closed position according to an exemplary embodiment according to an exemplary embodiment.

FIG. 2 illustrates an exploded view of the container of FIG. 1 with the drawer on the lid in an open position.

FIG. 3 illustrates a cross section side view showing the container of FIG. 1 with the drawer closed prior to dispensing material into a glass according to an exemplary embodiment.

FIG. 4 illustrates a cross section side view showing the container of FIG. 1 with the drawer open for dispensing material into a glass according to an exemplary embodiment.

FIG. 5 illustrates a perspective view of container lid with combined funnel and dispenser drawer shown in a closed position according to an exemplary embodiment.

FIG. 6 illustrates a perspective view of the container lid of FIG. 5 with the dispenser drawer shown in an open position according to an exemplary embodiment.

### DETAILED DESCRIPTION

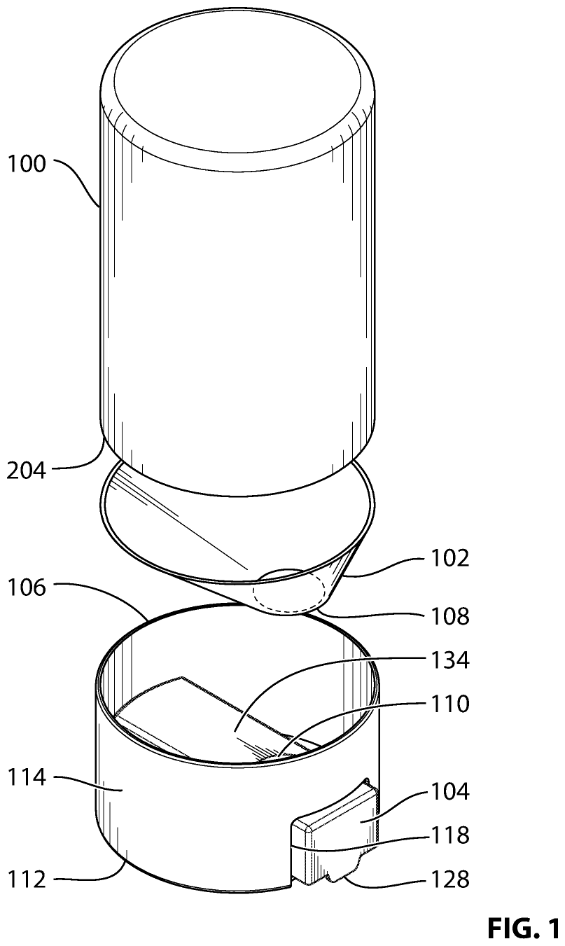

FIG. 1 illustrates an exploded view of a container 100 with integrated funnel 102 and dispenser drawer 104 on the container's lid 106 according to an exemplary embodiment. The container 100 is shown upside down with the drawer 104 inserted into the lid 106 in a closed position and held within the lid 106. The container 100 has outer walls forming the outside shape of the container 100. A portion of the interior walls of the container 100 are generally frustoconical in shape and form the funnel 102 with a wide mouth of the funnel 102 toward the interior of the container 100 and a narrow stem 108 facing toward the lid 106. As illustrated in FIG. 1, the funnel 102 is not symmetrical and instead the funnel 102 walls are shaped to position the narrow stem 108 toward one side of the lid 106 just above a fill hole 110 on the drawer 104 when the drawer 104 is in the closed position. Although not illustrated in FIG. 1 to keep the diagram simple, locking seams or threads may be provided around outer or inner surfaces of the container 100 and/or lid 106 to allow securing the lid 106 to the top of the container 100. Any desired securing means for connecting the lid 106 to the container 100 may be included such as threads, latches, snap locks, etc.

As illustrated, the lid 106 includes a circular base 112 with sidewalls 114 extending perpendicular off the perimeter of the base 112. The diameter of the base 112 may be designed such that the inner surface of the sidewalls 114 engages with locking seams or threads on the outer surface around the container 100 thereby allowing the lid 106 to be secured to the container 100. The perpendicular sidewalls 114 have a drawer opening 118 allowing the drawer 104 to extend outward in an open configuration in order to be accessed by a user.

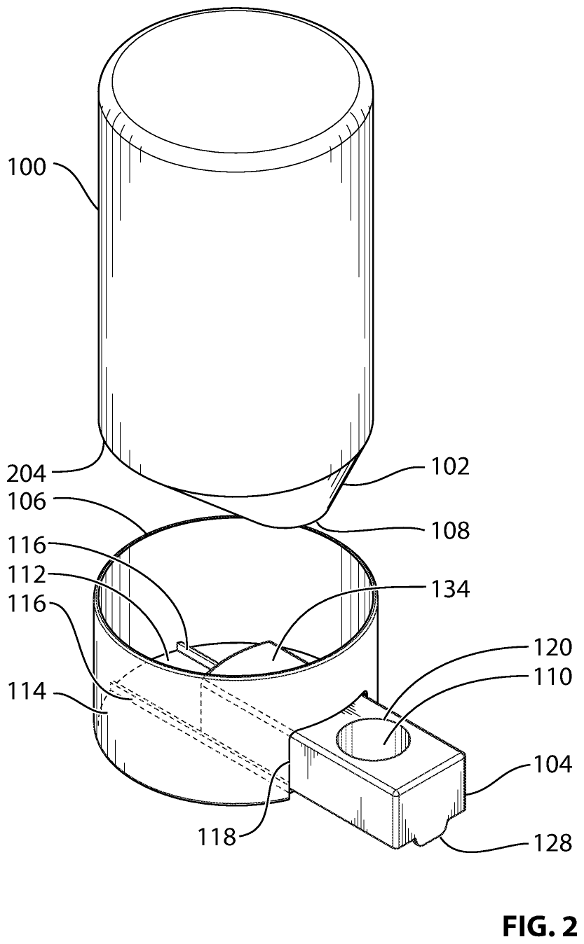

FIG. 2 illustrates an exploded view of the container 100 and lid 106 of FIG. 1 with the drawer 104 pulled out from the lid 106 in an open position. The lid 106 includes one or more drawer guides 116 such as tracks that run across the inside surface of the lid 106 intersecting a center of the lid 106 and the perpendicular sidewalls 114. The dispenser drawer 104 is movable along the drawer guides 116. In the container orientation as illustrated, the drawer 104 includes a receptacle 120 being a cylinder with the fill hole 110 on a container-facing side 134 of the drawer 104 and a dispensing hole 122 on an exterior-facing side of the drawer 104. The cylindrical receptible 120 is mounted within the drawer 104 and moves back and forth as a result of the motion of the drawer 104 moving between the open and closed positions.

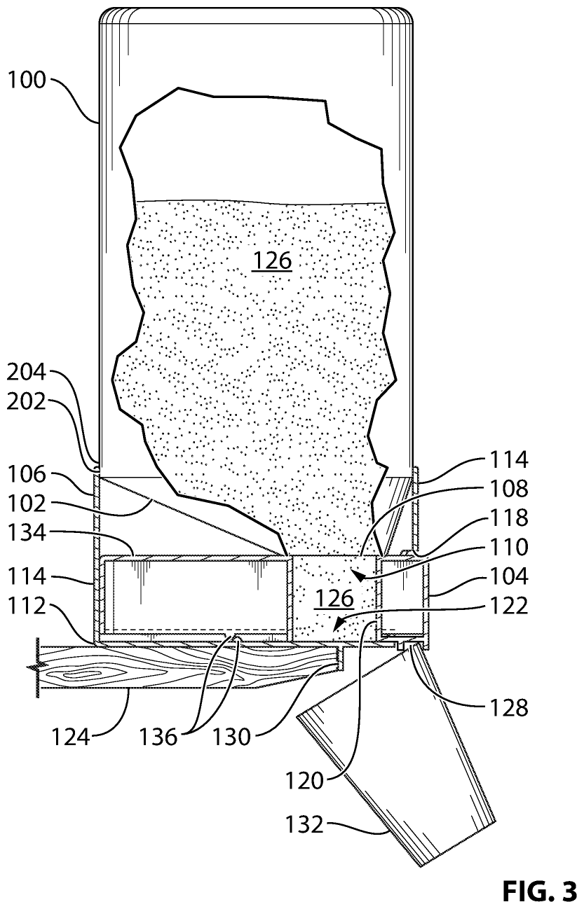

FIG. 3 illustrates a cross section side view showing the container 100, intermediate funnel 102 and lid 106 of FIG. 1 secured together and positioned on the edge of a table 124 with the drawer 104 in the closed position prior to dispensing material 126 according to an exemplary embodiment.

The container 100 in this embodiment is filled with free-flowing material 126 such as powered or other dry granular material 126 that has fluid-like characteristics. For instance, in some applications, the material 126 may be protein powder utilized by body builders. The material 126 may be pre-filled into the container 100 prior to the inner walls forming the funnel 102 being attached within the container 100. Alternatively, the inner walls forming the funnel 102 may already be present within the container 100 and the filling process is done by injecting or otherwise pouring material into the container 100 via the narrow stem 108 of the funnel 102. During the filling process, the vertical orientation of the container 100 may be opposite as illustrated such that the lid 106 and funnel 102 are at the top of the container 100 and removed for filling material 126 into the body of the container 100.

The material 126 is held within the enclosed space of the container 100 and funnel 102 such that when the container 100 is turned upside down, as illustrated in FIG. 3, the material 126 flows downward toward the funnel stem 108. The outside end of the drawer 104 has a shape that generally matches the curvature of the sidewalls 114 such that the drawer 104 end appears to a part of the sidewalls 114; however, the end of the drawer 104 extends outward slightly past the lid sidewalls 114 and includes a notch 128 or other grove or similar hooking mechanism on a bottom edge facilitating a user to pull the drawer 104 outward through the drawer opening 118. The base 112 of the lid 106 further includes an alignment ridge 130 protruding therefrom to help the user align the lid 106 with the side of the table top or other surface 124.

When the drawer 104 is in the closed positioned as illustrated in FIG. 3, the funnel's narrow stem 108 is directly above the receptacle's fill hole 110 and material 126 in the container 100 is directed by the funnel 102 to flow into the receptacle 120 under the force of gravity. The receptacle's dispensing hole 122 is blocked by the base 112 of the lid 106 and therefore flow of material 126 stops once the receptacle 120 is full because material 126 within the receptacle 120 has nowhere to go.

Alignment of the fill hole 110 and the funnel stem 108 may be ensured by the one or more stoppers on the threads or sealing ring of the container 100 and/or lid 106 such that, when the lid 106 is snuggly screwed onto the container 100, the lid 106 stops turning right at the point that the funnel stem 108 is aligned with the fill hole 110. Visual indications such as alignment marks on one or more of the lid 106 and container 100 may also help the user ensure alignment. The user may turn the lid 106 on the container 100 to ensure that a first alignment mark on the lid 106 lines up with a second alignment mark on the container 100 outer wall. Other types of mounting and alignment hardware may be utilized such as alignment ridges and notches in conjunction with snaps or latches to hold the lid 106 on the container 100. Likewise, for embodiments with standalone funnels 102, the funnel 102 and the lid 106 may include alignment ridges and/or notches and/or visible marks helping the user to ensure that the funnel 102 and lid 106 couple together in the correct relative orientations such that the funnel stem 108 is directed toward the receptacle fill hole 110 when the drawer 104 is in the closed position.

When the user is ready to dispense material 126 from the container 100, the user inserts an edge of a glass or other receiving container 132 into the notch 128 on the end of the drawer 104. The user then moves the receiving container 132 away from the container lid 106 thereby pulling the drawer 104 out of the lid 106 and into an open position.

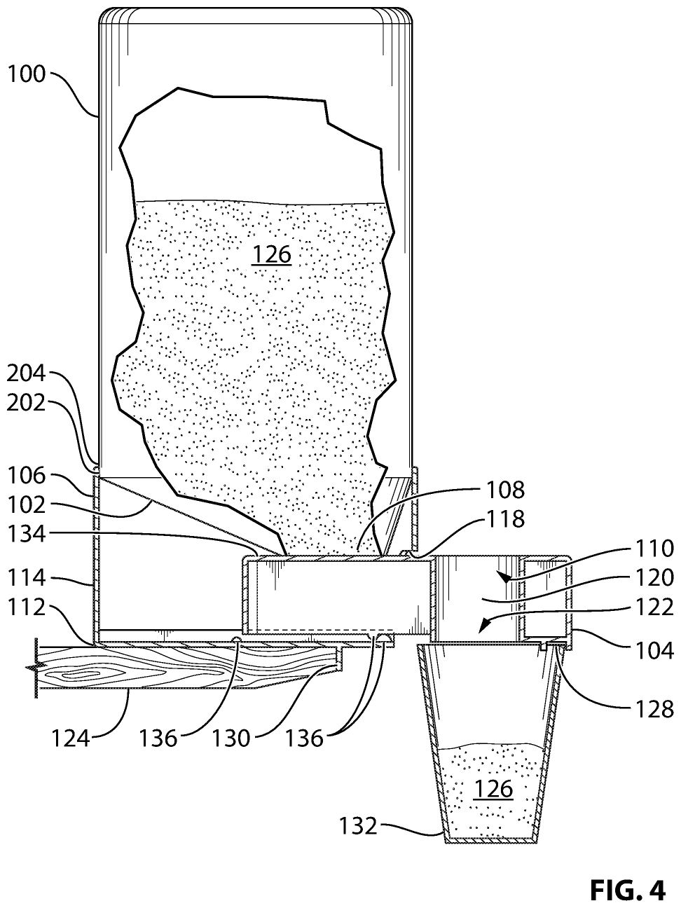

FIG. 4 illustrates a cross section side view showing the situation after the drawer 104 has been moved by the user into the open position causing material 126 in the receptacle 120 to be dispensed into the user's glass or other receiving container 132.

The top facing side 134 of the drawer 104 as shown in the orientation of FIG. 4 is solid except for the fill hole 110 into the receptacle 120. In this way, material 126 that would flow out of the narrow stem 108 of the funnel 102 can only enter the receptacle 120 when the fill hole 110 is aligned with the funnel stem 108. This happens when the drawer 104 is in the closed position as illustrated in FIG. 3. Once the drawer 104 is pulled outward by the user into the open position as illustrated in FIG. 4, the fill hole 110 is moved away from the funnel stem 108 and the solid surface 134 of the drawer 104 blocks the funnel stem 108. Material 126 cannot flow out of the funnel stem 108 when the drawer 104 is in the open position due to being blocked by the drawer's solid surface 134.

On the other hand, when the drawer 104 is in the open position as illustrated in FIG. 4, there is nothing blocking the receptacle's dispensing hole 122 and therefore the material 126 within the receptacle 120 falls out of the dispensing hole 122 under the force of gravity. As the user is opening the drawer 104, as soon as a part of the dispensing hole 122 leaves the confines of the lid base 112 perimeter, the material 126 within the receptacle 120 will start to flow out of the now-open part of the dispensing hole 122. As illustrated in FIG. 3 and FIG. 4, because the user has already positioned their glass or other receiving container 132 under the dispensing hole 122, as soon as the dispensing hole 122 starts to exit the lid 106, material 126 will fall directly into the user's glass or other receiving container 132.

The user may visually inspect the receptacle 120 and ensure that all material 126 within the receptacle 120 has fallen into the user's glass or other receiving container 132. When the drawer 104 is in the open position, the fill hole 110 of the receptacle 120 is visible to the user and allows the user to see into the receptacle 120 to ensure the receptible 120 is empty. In the case of protein powder or other similar materials 126, there may be some powder that sticks to the inner sides of the receptacle cylinder 122. In this case, the user may lightly tap the drawer 104 in order to dislodge the stuck material 126 and cause it to fall out the dispensing hole 122.

After the user has confirmed that all material 126 in the receptacle 120 has been dispensed, the user moves the drawer 104 back into the closed position. Retainer hubs 136 such as rubber stoppers or indents may be included on the drawer 104 and/or the drawer guides 116 to provide a friction-based locking system that holds the drawer 104 in the closed position until a force by the user pulling the drawer 104 outward exceeds a predetermined threshold. The retainer hubs 136 further provide tactile feedback allowing the user to feel when the drawer 104 is locked in the closed position.

If the user desires to dispense more material 126, the above process of opening the drawer 104 may be repeated as many times as needed. Depending on the flow characteristics of the material 126 within the container 100, the time between closing the drawer 104 and opening to dispense another batch of material 126 may be adjusted by the user. For quickly flowing material 126, the drawer 104 may be closed and then opened as fast as the user can physically move the drawer 104. In this way, the user may dispense material 126 any number of times in rapid succession. For other types of materials 126 that flow a bit slower or tend to stick, the user may need to pause each time the drawer 104 is closed, and it may likewise be beneficial for the user to tap the container 100 while the drawer 104 is closed in order to ensure that the receptacle 120 is completely filled with material 126 before opening the drawer 104 again.

When pulling the drawer 104 out of the container lid 106 and pushing the drawer 104 back into the container lid 106, the user may hold the glass or other receiving container 134 in one hand and support the body of the container 100 with another hand. In this way, the forces caused by the user moving the drawer 104 between the closed and open positions will not cause the container 100 to fall off the edge of the table 124 or otherwise tip over. Friction pads such as rubber stoppers may also be included or applied to the table-facing side of the base 112 of the lid 106 in order to prevent slippage of the lid base 112 along the table 124 surface.

Because the container lid 106 dispenses material 126 directly into the user's glass or other receiving container 134, there is no requirement for the user to open the container 100 to scoop out material 126. The container 100 may remain shut and the only portion of material 126 within the container 100 that is exposed to the outside air is the material 126 at the end of the funnel stem 108 narrow end right before it enters the receptacle's fill hole 110. Furthermore, each time the drawer 104 system is utilized to dispense material 126, the material 126 that has been exposed to the outside air is immediately dispensed. Taking protein powder as an example of the material 126, any bacteria or mold that may be present in the air and reach the powder at the end of the funnel stem 108 does not have much time to grow before being dispensed by the user the next time the drawer 104 is opened. This is unlike in prior art containers where the container needs to be opened in order for powder to be scooped out by the user. When opening a container, contaminants may enter the container and have long periods of time to grow and spread within the container without ever being scooped out by the user.

Cleanliness may also be beneficially enhanced by a container lid 106 with integrated dispenser drawer 104 as disclosed herein. There is no dusty scoop that needs to be handled by the user during regular usage and the user's hands may instead simply hold their glass, cup, or other receiving container 134. Likewise, no dusty scoop needs to be placed somewhere in order to for the user to stir dispensed materials 126 such as protein powder into a drink. Instead, the drawer 104 dispenses the material 126 directly into the receiving container 134. After dispensing, the user simply closes the drawer 104 on the lid 106 and can continue with other steps required to use the dispensed material 126 without needing to worry about cleaning, returning a scoop, or re-attaching the lid 106 on the container 100 to close the container 100 as is required in typical prior art containers. Beneficially, the user may not even need to let go of their glass or other receiving container 134 as the drawer 104 can be opened and closed while the user holds the glass or other receiving container 134. In some cases, the receiving container 134 can be a mixer and the dispensed material 126 is dispensed directly into the mixer without an intermediate scoop or container lids to be dealt with prior to mixing.

In some embodiments, a rubber or silicon seal extends from the stem 108 of the funnel 102 and slides against a solid surface of the stem-facing side 134 of the drawer 104 while the drawer 104 is moved between the closed position and the open position. The seal ensures that the material 126 does not leak out a gap between the surface 134 of the drawer 104 and the stem 108 of the funnel 102. The seal may spread out in a circular shape against the solid surface 134 of the drawer 104 and hold material 126 that flows out the funnel stem 108 against the solid surface 134 of the drawer 104. When the user moves the drawer 104 into the closed position, the fill hole 110 slides into the circumference of the seal and material 126 can thereafter flow into the receptacle 120. A similar seal may also be provided at the dispensing hole 122 to prevent material 126 from leaking out the gap between the drawer's dispensing hole 122 and lid base 112.

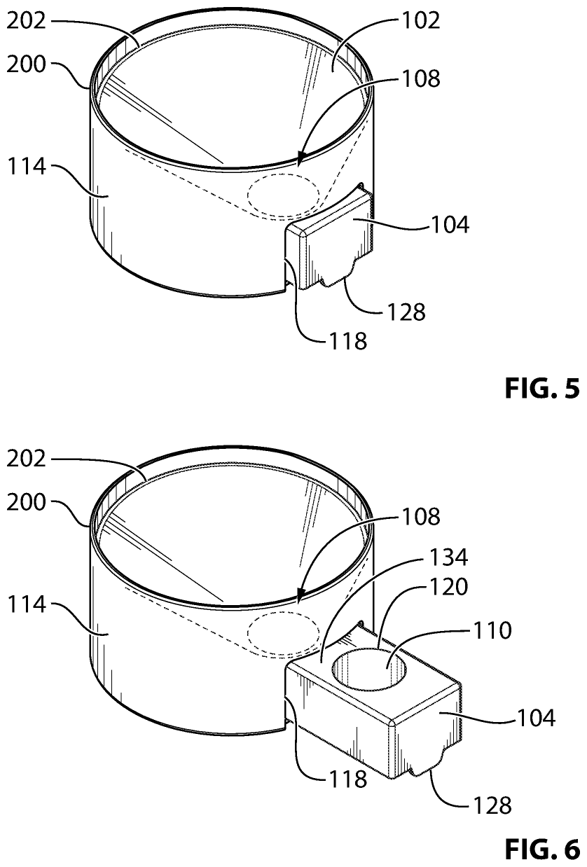

FIG. 5 illustrates a perspective view of container lid 200 having integrated funnel 102 and dispenser drawer 104 shown in a closed position according to an exemplary embodiment. FIG. 6 illustrates a perspective view of the container lid 200 of FIG. 5 shown in an open position.

The embodiment of FIG. 5 and FIG. 6 is similar to that shown above in FIG. 1 to FIG. 4 except now the funnel 102 is integrated within the lid 200 itself. The entire drawer 104 mechanism including the funnel 102, guide tracks 116, and drawer 104 fit into and are securely mounted on the lid 200. In this embodiment, the funnel stem 108 is mounted to a frame of the drawer guide 116 while the edges 202 around the mouth of the funnel 102 are connected around the inner side of the sidewalls 114. The funnel mouth edges 202 meet the sidewalls 114 at a height configured to match the top edge 204 of the container 100 when the lid 106 is tightly screwed or otherwise secured onto the container 100. In this way, the funnel mouth top edge 202 is tucked under the container top edge 204 giving a tight seal when lid 106 is tightened to the container 100. When the combination of the container 100 and lid 106 is flipped upside down and placed lid-side-down on the countertop or other flat surface 124 as shown in the various illustrations herein, the material 126 in the container 100 follows the funnel 102 and flows out the funnel stem 108 into the fill hole 110 on the receptacle 120. The operation of the embodiment of FIG. 5 and FIG. 6 is otherwise the same as previously described for the above embodiments.

An advantage of integrating the funnel 102 into the lid 200 as is done in FIG. 5 and FIG. 6 includes allowing the lid 106 to be used in conjunction with typical prior art containers 100 that do not contain an integrated funnel 102 or inner walls forming the funnel 102 within the container 100. Another advantage is that the container 100 is easier to be cleaned and refilled by a user. For instance, a user may purchase more product 126 such as a protein powder in an environmental friendly bag when restocking the container 100 rather than purchasing a new container 100 with integrated lid 106 each time more product is desired. Removing the lid 106 leaves a normal container 100 that is open at the top and easy to refill. Costs of refiling the container 100 may thereby be reduced. Yet another advantage of integrating the funnel 102 on the lid 106 is that the funnel stem 108 is always ensured to align with the fill hole 110 on the receptacle 120.

According to an exemplary embodiment, a drawer based dispensing system includes a drawer 104 with receptacle 120 moveable along a guide track 116 between open and closed positions. During usage, a fill hole 110 allows material from a container 100 to enter the receptacle 120 on a side of the drawer 104 that faces an interior of the container 110 when the drawer 104 is positioned in the closed position. A dispensing hole 122 allows material 126 to exit the receptacle 120 on an opposite side of the receptacle 120 away from the interior of the container 100 when the drawer 104 is positioned in the open position. The dispensing system may be integrated into a lid 106 of the container 100 which is flipped to sit lid-side-down by a user. A funnel 102 may direct material 126 into the fill hole 110. The drawer 104 may extend to outside the container 100 through a drawer opening 118 in the container or lid sidewalls 114 to expose the dispensing hole 122.

Although the invention has been described in connection with preferred embodiments, it should be understood that various modifications, additions and alterations may be made to the invention by one skilled in the art without departing from the spirit and scope of the invention. For example, although the above-description has described the funnel stem 108 being offset to a side of the container 100 when viewed from the top, in other embodiments, the funnel 102 is symmetrical and the stem 108 is in the center of the container 100. Having the stem 108 offset to a side as illustrated in the above examples is helpful to allow positioning the container 100 on the edge of a table 124 or countertop such that the drawer end 104 sticks out over the edge a bit allowing the user to position the edge of a glass or other receiving container 134 on the grove 128 of the drawer 104 in order to open the drawer 104. Because the drawer 104 does not need to be pulled out very far before the dispensing hole 122 of the drawer 104 emerges, the glass or other receiving container 134 held by the user when opening the drawer 104 does not need to be very wide. However, embodiments where the funnel stem 108 is in the center of the container 100 and/or lid 106 may be beneficial to accommodate wider receiving containers 134. Likewise, in some applications, there is no requirement to sit the container 100 on the edge of the table 124 and instead the container 100 may be suspended in a holder or via cords from an upper mount. In these cases, the drawer 104 may be easier to access closer to the center of the container diameter rather than the drawer end 104 right at the container's exterior perimeter.

In yet other embodiments, the drawer 104 is shorter than a diameter of the container lid 106 and moves back and forth along the tracks 116 but always contained within the sidewalls 114. The sidewalls 114 are therefore of continuous design without any drawer opening 118. The base 112 of the lid 106 includes slots running parallel with the drawer guides 116 through which protrusions from the drawer 104 extend thereby allowing the user's glass 132 to catch the protrusions and move the drawer 104 back and forth along the guide tracks 116. The lid base 112 has a dispensing hole such that, when the drawer 104 is moved to an open position, the dispensing hole 122 on the receptacle 120 is aligned with the dispensing hole on the base 112 and material 126 in the receptacle 120 falls out into the user's glass or other receiving container 134 under force of gravity. Again, depending on the application and design requirements, the funnel stem 108 may be centered or may be offset depending on where the drawer 104 will position the fill hole 110 on the receptacle 120 in the closed position. A benefit of this embodiment is that the drawer 104 never extends out of the confines of the lid 106 and therefore is unlikely to be accidently broken off or inadvertently damaged.

A temporary and removable seal may be applied across the open top end of the container 100 to keep the material 126 fresh until first use. In cases where the funnel 102 is integrated on the lid 106, the temporary seal may be applied across the entire top of the container 100 for removal by the user after purchase. In cases where the funnel 102 is integrated into or otherwise formed by inner walls of the container 100, the seal may just be across the funnel stem 108 for removal by the user. If there are outer walls on the container 100 that are wider than the funnel stem 108, instructions or other printed collateral can be inserted into the gap between the outer walls and the funnel 102 without contaminating the material 126 held within the container 100 and without the printed collateral getting dusty during transport of the container 100 prior to purchase by an end user.

Although this disclosure has focused on the drawer 104 dispensing system being integrated into a lid 106, it is to be understood that the term “lid” refers generally to a cap on an end of the container 100 and need not be on the top of the container at all times. In the embodiments described above, the lid 106 with integrated drawer dispenser 104 is likely on the top of the container after filling and during transport, but the entire assembly is flipped upside down by the user during usage for easy dispensing through the drawer 104 on the lid 106 now positioned on the bottom of the container 100. To avoid the end user needing to flip the container 100 upside down, in other embodiments, the base of the container may also be considered a lid 106 with an integrated drawer dispenser 104. In such embodiments, another container lid on the opposite (i.e., top) end may be a normal, prior art lid that is openable by the user in order to refill the container 100 at any time. A dispenser drawer 104 system as described herein may be integrated into the lid 106, the base or any other part of the container 100 in difference embodiments.

In some embodiments, the receptacle cylinder 120 is removable in order to clean the receptacle 120 or to change the size of the receptacle 120 for different applications. The drawer 104 may have a ridges or snaps to hold a receptacle block in position within the drawer 104, and a plurality of different receptacle blocks may have different sized receptacles 120 in order to hold different amounts of material 126. Likewise, the drawer 104 may be removable by the user such as by overcoming the end stopper 136 friction force and pulling the drawer 104 out the drawer opening 118. Removing the drawer 104 allows better cleaning within the lid 106, especially for embodiments where the funnel 102 is integrated in the lid 106 itself as illustrated in FIG. 5 and FIG. 6.

Functions of single elements may be separated into multiple units, or the functions of multiple elements may be combined into a single unit. For example, rather than being integrated with one of the container 100 and the lid 106, the funnel 102 may be a separate, standalone component that sits between the container 100 and the lid 106 and is held between them when the lid 106 is secured to the top of the container 100. Likewise, the funnel 102 may be not be required for some applications and embodiments. For instance, the outer walls of the container may naturally act as a funnel because the container 100 is shaped such that material 126 will naturally fall toward a lowest point at which a spout of the container 100 meets the fill hole 110 of the receptacle 120 with the drawer 104 is in the closed position. Having a funnel-shape directing material into the receptacle 120 whether provided by an actual funnel 102 or just by the shape of the container 100 is beneficial to make sure all material 126 can be dispensed; however, as long as the material 126 within the container is sufficient, a funnel 102 may not be required in some applications and embodiments.

Although the circular shapes are illustrated herein, the body of the container 100 and lid 106 may be other shapes such as square or rectangular in other embodiments. The steps of the dispensing material 126 from a container 100 with dispenser drawer 104 as described above are not restricted to the exact order described, and, in other configurations, described steps may be omitted or other intermediate steps added. All combinations and permutations of the above described features and embodiments may be utilized in conjunction with the invention.

What is claimed is:

1. A lid for mounting on a container, the lid comprising:
a base;
a drawer guide on the base;
a drawer having a predetermined height mounted on the drawer guide and moveable along the drawer guide between an open position and a closed position;
a receptacle for temporarily storing an amount of material within the predetermined height of the drawer;
a fill hole on a side of the drawer that faces an interior of the container, the fill hole allowing a material in the container to enter the receptacle when the drawer is positioned in the closed position; and
a dispensing hole on an opposite side of the receptacle away from the interior of the container, the dispensing hole allowing material to exit the receptacle when the drawer is positioned in the open position.

2. The lid of claim 1, wherein a surface of the drawer that faces the interior of the container is solid except for the fill hole.

3. The lid of claim 1, wherein:
a stem of a funnel directs the material into the fill hole when the drawer is in the closed position; and
a solid outside surface of the drawer when the drawer is not in the closed position blocks the stem of the funnel thereby preventing the material from leaving the stem of the funnel.

4. The lid of claim 1, further comprising:
a funnel;
the funnel having a mouth directed toward the interior of the container, the mouth having an outer diameter substantially matching an inner diameter of the container; and
a stem of the funnel directed toward a position at which the fill hole is located when the drawer is in the closed position.

5. The lid of claim 4, wherein a perimeter of the mouth of the funnel is connected to a sidewall extending perpendicular from the base.

6. The lid of claim 4, wherein the mouth of the funnel reaches a height on a sidewall such that a top edge of the container meets the mouth of the funnel when the lid is secured to the container.

7. The lid of claim 1, further comprising a seal that extends from a stem of a funnel and slides against a solid outside surface of the drawer while the drawer is moved between the closed position and the open position, whereby the seal ensures that the material does not leak out a gap between a surface of the drawer and the stem of the funnel.

8. The lid of claim 1, wherein:
a sidewall extending perpendicular off the base includes a drawer opening at an end of the drawer guide; and
the drawer extends out of the drawer opening in order to expose the dispensing hole of the receptacle and allow the material to exit the receptacle when the drawer is positioned in the open position.

9. The lid of claim 1, wherein:
a sidewall extending perpendicular off the base extends a full perimeter of the base;
the base includes a first dispensing hole that aligns with a second dispensing hole below the receptacle on the drawer to allow the material to exit the receptacle when the drawer is positioned in the open position.

10. The lid of claim 1, further comprising one or more stoppers on the drawer guide locking the drawer in the closed position until a friction force provided by the stoppers is overcome.

11. The lid of claim 1, further comprising a groove provided on the drawer for accepting an edge of a receiving container held by a user thereby allowing the user to move the drawer between the closed position and the open position by moving the receiving container back and forth.

12. The lid of claim 1, further comprising a protruding edge on a side of the base opposite the interior of the container, the protruding edge facilitating positioning the container lid-side-down overhanging over an edge of a flat surface.

13. The lid of claim 1, wherein the receptacle is removable from the drawer.

14. The container comprising the lid of claim 1.

15. The container of claim 14, further comprising an integrated funnel having a stem that aligns with the fill hole of the receptacle when the drawer is in the closed position.

16. The container of claim 14, further comprising:
a funnel attached to the container;
a non-centered stem of the funnel being offset to a side of the funnel;
a first alignment means on the container; and
a second alignment means on the lid;
wherein the fill hole of the drawer in the closed position is non-centered by being offset to a sidewall of the lid; and
positions of the first alignment means and the second alignment means are such that when the lid is attached to the container with the first alignment means adjacent to the second alignment means, the non-centered stem of the funnel aligns with the fill hole of the drawer in the closed position.

17. The container of claim 14, further comprising
a standalone funnel having a non-centered stem being offset to a side of the standalone funnel;
a first alignment means on the standalone funnel; and
a second alignment means on the lid;
wherein the fill hole of the drawer in the closed position is non-centered by being offset to a sidewall of the lid; and
positions of the first alignment means and the second alignment means are such that when the lid is attached to the container with the first alignment mark adjacent to the second alignment mark, the non-centered stem of the standalone funnel aligns with the fill hole of the drawer in the closed position.

18. The container of claim 14, wherein friction pads are applied on a side of the base opposite the interior of the container.

19. The container of claim 14, wherein an outer wall of the container forms a spout to direct material into the fill hole of the receptacle when the drawer is in the closed position.

20. A method of dispensing a material from a container having a lid with an integrated dispenser drawer, the method comprising:
orientating the container such that the container is lid-side-down;
hooking a receiving container on a grove connected to the integrated dispenser drawer;
moving the receiving container in a first direction to thereby move the integrated dispenser drawer from a closed position to an open position and dispense a fixed amount of the material from a receptacle in the integrated dispenser drawer into the receiving container under a force of gravity via a dispensing hole under the receptacle;
moving the receiving container in a second direction opposite the first direction to thereby move the integrated dispenser drawer from the open position to the closed position and cause a fill hole above the receptacle to align internally with a fill stem internally thereby refilling the receptacle in the integrated dispenser drawer with new material from an interior of the container; and
repeating moving the receiving container back and forth in order to repeatedly move the integrated dispenser drawer between the closed position and the open position any number of times in order to dispense a desired amount of the material into the receiving container.
